(19) United States
(12) Patent Application Publication
(10) Pub. No.: US 2003/0160425 A1
(43) Pub. Date: Aug. 28, 2003

(54) Motorcycle leg shields

(76) Inventors: Lance Hyndman, St. Albert (CA); Larry Strilchuk, Clyde (CA); Romain Joseph Alphonse Turgeon, Morinville (CA)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/090,486

(22) Filed: Feb. 28, 2002

(30) Foreign Application Priority Data
Feb. 26, 2002 (CA) 2,373,297

(51) Int. Cl. B62H 1/00

(52) U.S. Cl. 280/304.3

(57) ABSTRACT

A motorcycle leg shield which includes a first aerodynamic shell-form body adapted to cover a left leg of an operator of a motorcycle and a second aerodynamic shell-form body adapted to cover a right leg of an operator of a motorcycle. Clamps are provided for securing the first aerodynamic shell-form body and the second aerodynamic shell-form body to a motorcycle. One or more ventilation ports are provided in each of the first aerodynamic shell-form body and the second aerodynamic shell-form body. Each ventilation port has a closure having a closed position blocking air flow through the ventilation port and an open position allowing air flow through the ventilation port.

### FIELD OF THE INVENTION

The present invention relates to motorcycle leg shields.

### BACKGROUND OF THE INVENTION

Motorcycle leg shields, or motorcycle fairing lowers as they are referred to by some manufacturers, are placed on motorcycles to shield the legs of the operator. In weather conditions not requiring the motorcycle leg shields, they can be removed.

### SUMMARY OF THE INVENTION

What is required is a motorcycle leg shield that can be readily adapted to suit changing weather conditions.

According to the present invention there is provided a motorcycle leg shield which includes a first aerodynamic shell-form body adapted to cover a left leg of an operator of a motorcycle and a second aerodynamic shell-form body adapted to cover a right leg of an operator of a motorcycle. Means are provided for securing the first aerodynamic shell-form body and the second aerodynamic shell-form body to a motorcycle. One or more ventilation ports are provided in each of the first aerodynamic shell-form body and the second aerodynamic shell-form body. Each ventilation port has a closure having a closed position blocking air flow through the ventilation port and an open position allowing air flow through the ventilation port.

With the motorcycle leg shields, as described above, the operator is able to open the closure to provide air flow through the ventilation port when air flow is desired. When air flow is no longer desired, the operator is able to close the closure to block air flow through the ventilation port. As will hereinafter be further described, it is preferred if the closure is totally removable.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a perspective view of motorcycle leg shields fabricated in accordance with the teachings of the present invention.

FIG. 2 is a front elevation view of the motorcycle leg shields illustrated in FIG. 1, mounted on a motorcycle with ventilation port closures in the closed position.

FIG. 3 is a front elevation view of the motorcycle leg shields illustrated in FIG. 1, mounted on a motorcycle with ventilation port closures in the open position.

FIG. 4 is an exploded side elevation view of one of the motorcycle leg shields illustrated in FIG. 1.

FIG. 5 is a rear elevation view of one of the motorcycle leg shields illustrated in FIG. 1.

### DETAILED DESCRIPTION OF THE PREFERRED EMBODIMENT

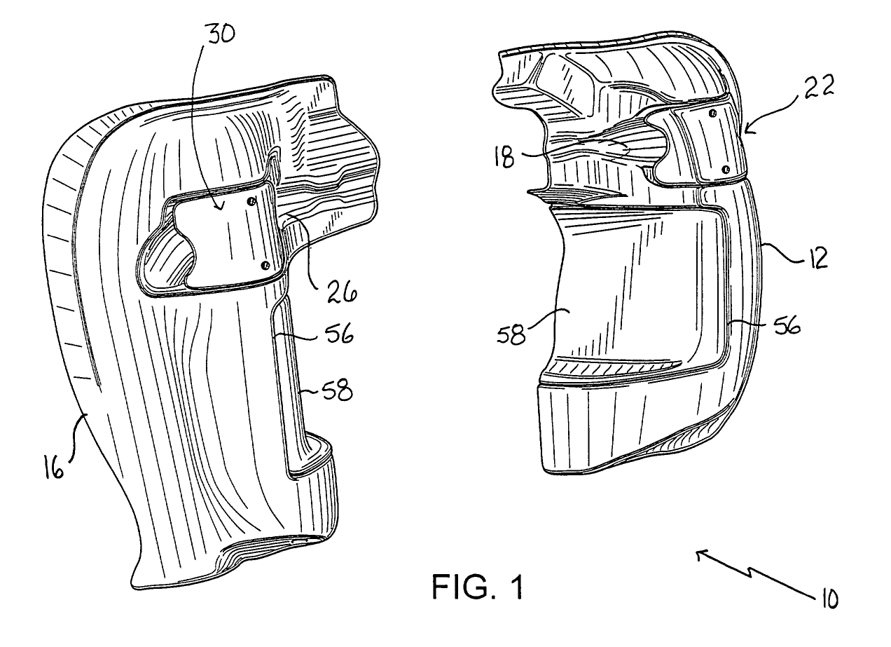

The preferred embodiment, motorcycle leg shields generally identified by reference numeral 10, will now be described with reference to FIGS. 1 through 5.

Structure and Relationship of Parts:

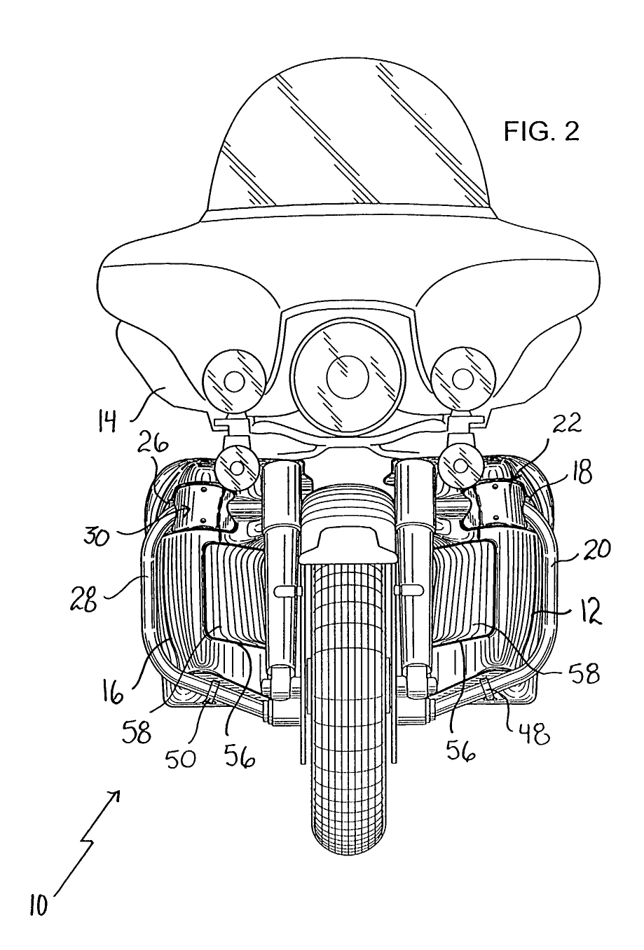

Referring to FIG. 2, there is provided a motorcycle leg shield 10 which includes a first aerodynamic shell-form body 12 that is adapted to cover a left leg of an operator of a motorcycle 14 and a second aerodynamic shell-form body 16 adapted to cover a right leg of operator of motorcycle 14.

Referring to FIG. 1, first aerodynamic shell-form body 12 has a first channel 18. Referring to FIG. 2, first channel 18 is adapted to receive a first tubular member 20 of motorcycle 14. A first clamping member 22 is provided that is adapted to retain first tubular member 20 of motorcycle in first channel 18. Referring to FIG. 1, second aerodynamic shell-form body 16 has a second channel 26. Referring to FIG. 2, second channel 26 is adapted to receive a second tubular member 28 of motorcycle 14. A second clamping member 30 is provided which is adapted to retain second tubular member 28 of motorcycle 14 in second channel 26.

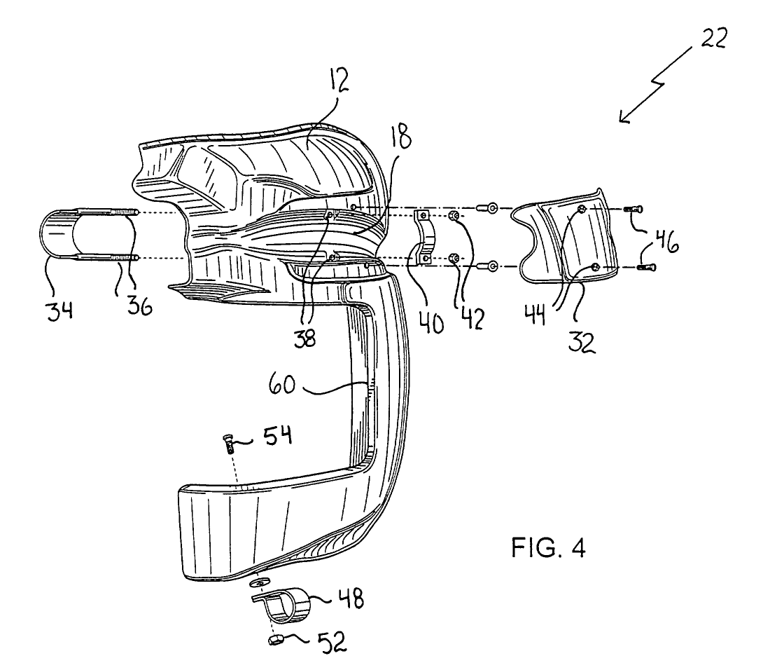

Referring to FIG. 4, first clamping member 22 includes a first portion 32 and a second portion 34. Second portion 34 of first clamping member 22 has elongate threaded posts 36 which are inserted through apertures 38 that are provided in first aerodynamic shell-form body 12. A bracket 40 is placed over elongate threaded posts 36 and nuts 42 are threaded onto elongate threaded posts 36 to secure second portion 34 of first clamping member 22 to first aerodynamic shell-form body 12. First portion 32 of first clamping member 22 has receiving apertures 44 that are adapted to receive securing fasteners such as threaded bolts 46 which are used to secure first portion 32 to first aerodynamic shell-form body 12. In the illustrated embodiment, only first clamping member 22 is shown, however it will be appreciated that second clamping member 30 is identical to first clamping member 22.

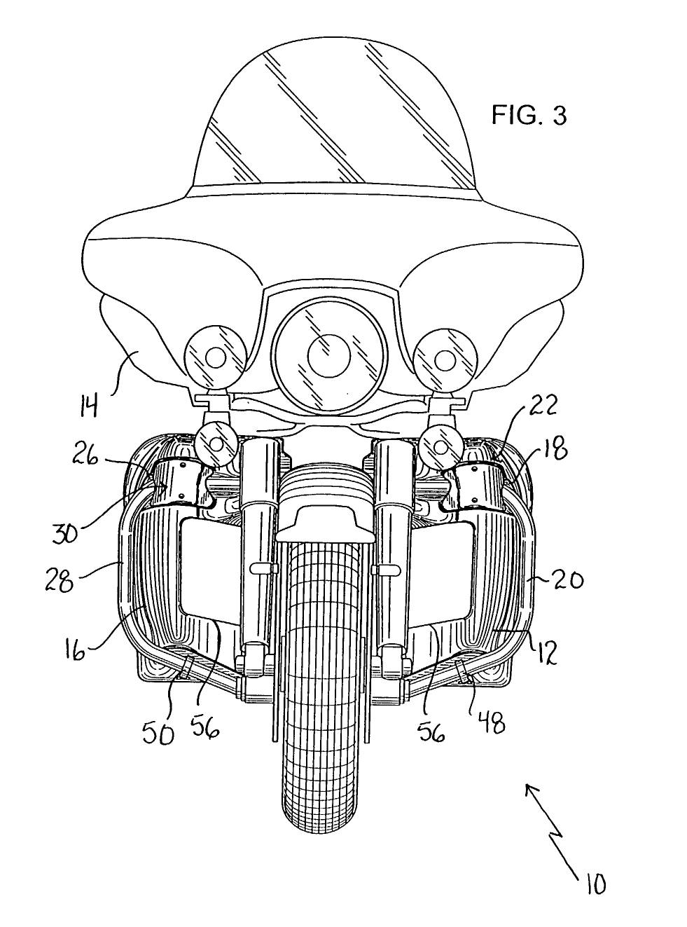

Referring to FIGS. 2 and 3, a first securing bracket 48 is provided which is adapted to be placed around first tubular member 20 and secured to first aerodynamic shell-form body 12. A second securing bracket 50 is also provided which is adapted to be placed around second tubular member 28 of motorcycle 14 and secured to second aerodynamic shell-form body 16. Referring to FIG. 4, threaded fasteners such as nuts 52 and bolts 54 can be used to secure first securing bracket 48 to first aerodynamic shell-form body 12. Second securing bracket 50 is secured in the same manner to second aerodynamic shell-form body 16.

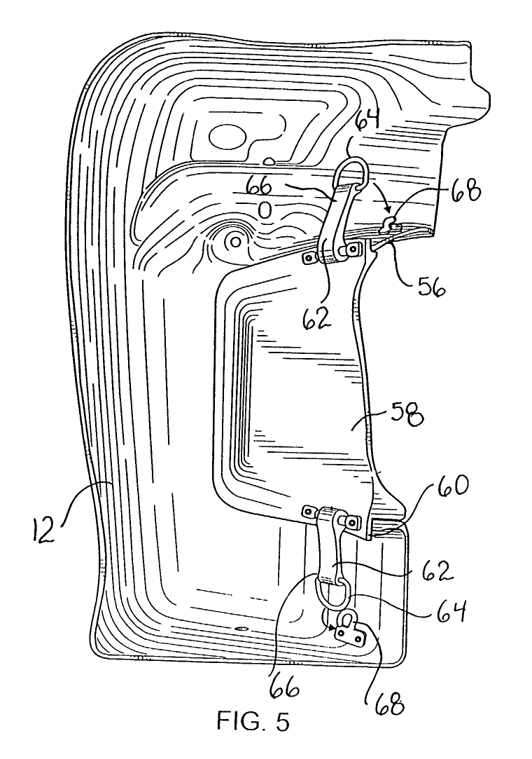

Referring to FIG. 2, a ventilation port 56 is provided in each of first aerodynamic shell-form body 12 and second aerodynamic shell-form body 16. A closure 58 is provided for each ventilation port 56 which has a closed position blocking air flow through ventilation port 56. Referring to FIG. 3, closure 58 also has an open position allowing air flow through ventilation port 56. Referring to FIG. 5, closure 58 has a retaining flange 60 that extends past ventilation port 56. Resilient straps 62 are secured to closure 58 for maintaining closure 58 in closed position. Eyelet fasteners 64 are positioned at remote ends 66 of resilient straps 62. Eyelet fasteners 64 are adapted to engage hooks 68 on each of first aerodynamic shell-form body 12 and second aerodynamic shell-form body 16.

Operation:

The use and operation of motorcycle leg shields generally identified by reference numeral 10, will now be described with reference to FIGS. 1 through 5.

Referring to FIG. 3, with motorcycle leg shields 10, as described above, depending on the weather conditions, the operator is able to open closure 58 to provide air flow through ventilation port 56 when air flow is desired. Referring to FIG. 2, when air flow is no longer desired, the operator is able to close closure 58 to block air flow through ventilation port 56. As will hereinafter be further described, it is preferred that closure 58 is totally removable. Referring to FIG. 5, Closure 58 can be totally removed by unhooking eyelet fasteners 64 at remote ends of resilient straps 62 from hooks 68 on each of first aerodynamic shell-form body 12 and second aerodynamic shell-form body 16. Once eyelet fasteners 56 have been unhooked, closure 58 can be removed from ventilation ports 56 and stored elsewhere until closure 58 required again.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

The embodiments of the invention in which an exclusive property or privilege is claimed are defined as follows:

1. A motorcycle leg shield, comprising:
a first aerodynamic shell-form body adapted to cover a left leg of an operator of a motorcycle;
a second aerodynamic shell-form body adapted to cover a right leg of an operator of a motorcycle;
means for securing the first aerodynamic shell-form body and the second aerodynamic shell-form body to a motorcycle;
at least one ventilation port in each of the first aerodynamic shell-form body and the second aerodynamic shell-form body, the at least one ventilation port in each of the first aerodynamic shell-form body and the second aerodynamic shell-form body being closed by a closure having a closed position blocking air flow through the ventilation port and an open position allowing air flow through the ventilation port.

2. The motorcycle leg shield as defined in claim 1, wherein the means for securing the first aerodynamic shell-form body and the second aerodynamic shell-form body to the motorcycle includes a channel adapted to receive a tubular member of the motorcycle and a clamping member adapted to retain the tubular member in the channel.

3. The motorcycle leg shield as defined in claim 1, wherein the closure has a retaining flange that extends past the ventilation port.

4. The motorcycle leg shield as defined in claim 1, wherein the closure is maintained in the closed position by resilient straps with fasteners at their remote ends which engage mating fasteners on one of the first aerodynamic shell-form body or the second aerodynamic shell-form body.

5. The motorcycle leg shield as defined in claim 1, wherein the fasteners at the remote ends of the resilient straps are eyelets which engage hooks on one of the first aerodynamic shell-form body or the second aerodynamic shell-form body.

6. A motorcycle leg shield, comprising:
a first aerodynamic shell-form body adapted to cover a left leg of an operator of a motorcycle and having a first channel adapted to receive a tubular member of the motorcycle;
a first clamping member adapted to retain the tubular member of the motorcycle in the first channel;
a second aerodynamic shell-form body adapted to cover a right leg of an operator of a motorcycle and having a second channel adapted to receive a tubular member of the motorcycle;
a second clamping member adapted to retain the tubular member of the motorcycle in the second channel;
a ventilation port in each of the first aerodynamic shell-form body and the second aerodynamic shell-form body;
a closure for each ventilation port having a closed position blocking air flow through the ventilation port and an open position allowing air flow through the ventilation port, the closure having a retaining flange that extends past the ventilation port;
resilient straps secured to the closure for maintaining the closure in the closed position, eyelet fasteners at remote ends of the resilient straps which are adapted to engage hooks on one of the first aerodynamic shell-form body or the second aerodynamic shell-form body.
